(19) United States
(12) Patent Application Publication
(10) Pub. No.: US 2017/0051730 A1
(43) Pub. Date: Feb. 23, 2017

(54) Relative Superluminal Propulsion Drive

(71) Applicant: Michael Wayne Brace, Saint Petersburg, FL (US)

(72) Inventor: Michael Wayne Brace, Saint Petersburg, FL (US)

(21) Appl. No.: 14/832,171

(22) Filed: Aug. 21, 2015

(51) Int. Cl. F03H 1/00

(52) U.S. Cl. CPC F03H 1/0081; F03H 1/0006

(57) ABSTRACT

A Relative Superluminal Propulsion Drive that allows for the electro-mechanical means by which a vehicle of mass can be accelerated to and maintain a relative velocity greater than the universal constant C (299,792,458 meters/second, the speed of light in a vacuum) between two fixed points in space when measured from a third fixed point in space. The propulsion drive is an array of electro-mechanical antennas positioned on the forward and aft portion of the vehicle and provides for the force of acceleration to the vehicle by lowering the pressure and density of the energy state of the area in front of the vehicle and increasing the pressure and density of the energy state behind the vehicle through the collection and re-distribution of that part of the electro-magnetic spectrum responsible for maintaining the average pressure density of the void energy of space. In addition to providing propulsion the Relative Superluminal Propulsion Drive accounts for and negates the effects of the Newton's Laws of Motion during both the acceleration and deceleration portion of the travel.

### FIELD

The invention relates to the field of propulsion and more particularly to an electro-mechanical propulsion drive which when attached to a vehicle consisting of mass will propel that vehicle across a measured distance of normal space between two fixed points in space at a velocity greater than 299,792,458 meters/second (the speed of light) when measured from a third non-associated point in space.

### BACKGROUND

Not all current theories about the physical makeup and the physical dynamics of the known universe are in agreement with each other. Historically most mainstream theories speculate that there are three states of existence in the known universe: matter (mass), energy and the vacuum of space (the void of space). Many of these same theories also postulate that there are four fundamental forces in the known universe: Gravity, Strong Nuclear, Weak Nuclear and those found in the Electro-magnetic energy spectrum. As science still struggles to identify and define the source of the force commonly referred to as gravity several modern theories have emerged that postulate a different theory to the source of the energy that provides the force of gravity.

These modern theories postulate that there are only two states of existence in the known universe: matter and energy, and that the void (or vacuum) of space is not a vacuum without substance at all but in fact another type of energy field. These modern theories postulate that the void is comprised of a latent state of energy of a hereto unknown classification (referred herein to as void energy). It has often been referred to as Dark Matter or Dark Energy in prior publications. Many of these theories are fundamentally based on the assumption that this void energy interacts with matter to create the force of gravity.

One such current theory has diverged from these alternate theories and has mathematically proven that gravity does not exist as a separate, unique force in the universe. Accordingly, if gravity it is not one of the four (4) fundamental forces of the known universe then the current theories about how matter is formed and how it behaves using gravitational mechanics may no longer be valid. Using the mechanical description of the interaction of the forces in the latter of one of these current theories (describing the fundamental forces of the universe) this invention clearly explains the mechanical means by which to propel a vehicle of mass though the vastness of space at a velocity faster than 299,792,458 meters/second (the accepted speed of light when traversing though the void of space) between two fixed points in space when measured from a third relative point in space.

More specifically, this innovation describes the methodologies by which an Relative Superluminal Propulsion Drive (RSPD) can be constructed utilizing the theory that gravity does not exist as a separate force in the universe, that the energy of the void (herein referred to as void energy) is responsible for the physical interaction of matter with itself (and with the other forces/energies of the universe) and that the pressure and density of the void energy is varied by the distribution of a boson common with in the electro-magnetic spectrum.

The mechanics by which to accelerate an object of mass to a velocity greater than its existing steady-state condition all have one property in common: they apply an accelerating force (or energy) to the object of mass being propelled. The current means by which those forces are applied, and the vector by which these forces are applied, fall into two (2) broad categories: Thrust Drive and Suction Drive.

A drive that provides an accelerating force to an object of mass (thereby accelerating that object of mass above a steady-state velocity) and that does so by creating a pressure gradient of a net-positive value behind the object of mass [relative to its direction of motion] greater than that of the local ambient pressure in front of the object of mass is a Thrust Drive.

With a Thrust Drive the accelerating force used to propel the object of mass is derived by increasing the pressure gradient reacting against the aft side of the object of mass and thus thrusting it in a forward direction. In such a configuration it is important to note that any and all forces reacting to the thrust being produced are at a localized nominal [average] value and that a net-positive energy amount has to been added to the local energy state surrounding the object of mass being propelled. An example of a Thrust Drive would be a rocket motor. The thrust of a rocket motor is derived from a chemical reaction that, when initiated releases the latent chemical energy in the fuel of the rocket motor which in turn increases the pressure behind the rocket motor providing a positive thrust to the aft end of the propulsion drive and accelerating the attached vehicle in a forward direction.

A Suction Drive is a drive that propels an attached vehicle in the forward direction by lowering the pressure gradient of the latent forces relative to the local ambient pressure in front of the propulsion drive. By lowering the pressure in front of the propulsion drive the ambient pressure around the propulsion drive attempts to equalize pressure about the propulsion drive. If the pressure in front of the propulsion drive is lowered in a vectored manner the propulsion drive will have a suction force applied to it in such a manner as to cause the propulsion drive to accelerate into the area of low pressure in front of it. An example of a Suction Drive is that of a propeller-driven vehicle. The shape of the propeller blades, in combination with the movement of these propeller blades through a compressible medium (air) causes an area of low pressure to form on top off and in front of the propeller blades. As the pressure gradient increases between the area of high pressure behind the propeller and the area of lower pressure in front of the propeller a force is applied to the propeller in an attempt to equalize the pressure between the front and back side of the propeller. In turn the propeller blades are sucked forward into the immediate area of low pressure in front of them. The vehicle attached to the propeller assembly accelerates with the propeller blades into the area of low pressure directly in front of them.

The Relative Superluminal Propulsion Drive described herein falls into the Suction Drive category.

### SUMMARY

A Relative Superluminal Propulsion Drive affixed to a properly configured vehicle that would allow same propulsion drive to travel a set distance between two fixed points in space at a relative velocity faster than 299,792,458 meters/second (the speed of light in a vacuum) when measured from a third point of view.

In previously described theories herein gravity does not exist as a fundamental force in the universe. Instead, these theories postulate that the void of space is comprised of an energy state that has an average density and pressure, and that the steady-state pressure gradient of the void provides the counter and opposing force to prevent any form of matter or energy approaching the speed of light to accelerate to a velocity faster than 299,792,458 meters/second, and that this void energy is the conductive energy that regulates the transmission speeds all forms of energy and mass traversing it.

Void energy must be subject to the same physical and dynamic laws of motion that are inherent to all forms of energy and matter in the universe and that it must have density and pressure in order to manifest itself in the physical universe, and it must be constrained by the same physical laws of motion and momentum as all other forms of energy in the known universe. Accordingly these same physical laws of motion dictate the maximum velocity at which any medium that can (and does) traverse through the void energy. The fastest velocity that can be achieved across the average pressure/density gradient of the void energy is the same as that for all energies in the electro-magnetic spectrum: 299,792,458 meters/second.

Since the absolute velocity of any form of particle, be it a massless energy particle (such as a Photon) or a particle of mass (such as a Proton) traveling through a medium [that provides resistance to that particle] is determined by the density and makeup of that medium, it is conceivable both energy and matter can travel faster between two fixed points in space if the void energy pressure and density in the path of those moving particles is less than the nominal/ambient pressure of void energy outside the path of those particles.

These same current theories concerning the void energy also postulate that the nominal pressure/density gradient of the void energy is maintained throughout the universe by the universal distribution and average density of a particular energy particle prevalent in the electro-magnetic spectrum, and that the average pressure gradient and density of the void energy can be changed with the addition or subtraction of that particle of the electro-magnetic spectrum that interacts with the pressure/density of the void energy. For the sake of brevity and consistency in this disclosure this particle of energy that affects void energy's pressure and/or density, and that causes localized changes to the void energy's pressure and/or density (due to its own localized density in the void energy) will be herein referred to as the triggering boson.

More specifically the Relative Superluminal Propulsion Drive (herein referred to as propulsion drive) described herein lowers the pressure and/or density of the ambient void energy in front of the propulsion drive by lowering the density of (absorbing) triggering boson in front of the propulsion drive, redistributing (adding) the triggering bosons to the aft of the propulsion drive and thereby causing the vehicle attached to the propulsion drive to be sucked [propelled] forward in space. It does so using conventional broadcasting and transmission methodology of electro-magnetic energy through the re-distribution of triggering boson from in front of the vehicle to the aft of the vehicle attached to the propulsion drive. This re-distribution of triggering boson in turn creates a lower void energy pressure/density gradient in front of the propulsion drive thus causing the attached vehicle to be propelled into this area of low pressure by the [now] higher pressure energy gradient of the void energy behind the propulsion drive. Since the pressure of the void energy in front of the propulsion drive is now lower than the normal (or ambient) pressure of the void energy behind the propulsion drive it is possible for objects of matter to be propelled at a relative velocity greater than 299,792,458 meters/second between two points in space as long as this void energy pressure gradient between the forward and the aft section of the propulsion drive is maintained at a sufficient lower level of intensity to achieve the desired speed.

As the density of the void energy decreases in front of the propulsion drive the propulsion drive is propelled into the void energy field at an ever increasing rate until steady-state pressure is maintained between the forward and the aft section of the propulsion drive. It is important to note that at no time does the propulsion drive, or the vehicle attached to it, ever exceed 299,792,458 meters/second relative to the density of its surrounding void energy space.

### BRIEF DESCRIPTION OF THE DRAWINGS

The drawings described herein are for illustration purposes only, the components are not scaled relative to each other, and accordingly they are not intended to limit the scope of the present disclosure in any way. The invention can be best understood by those having ordinary skill in the art by reference to the following detailed description when considered in conjunction with the accompanying drawings in which:

FIG. 1 illustrates a perspective view of the front/forward portion of the present disclosure.

FIG. 2 illustrates a perspective view of the aft/back portion of the present disclosure.

FIG. 3 illustrates an exploded perspective view from the front/forward portion of the present disclosure.

FIG. 4 illustrates a sectional side view with a cut-away section illustrating the internal arrangement of the present disclosure.

FIG. 5 illustrates a side view of the present disclosure in its operating environment.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

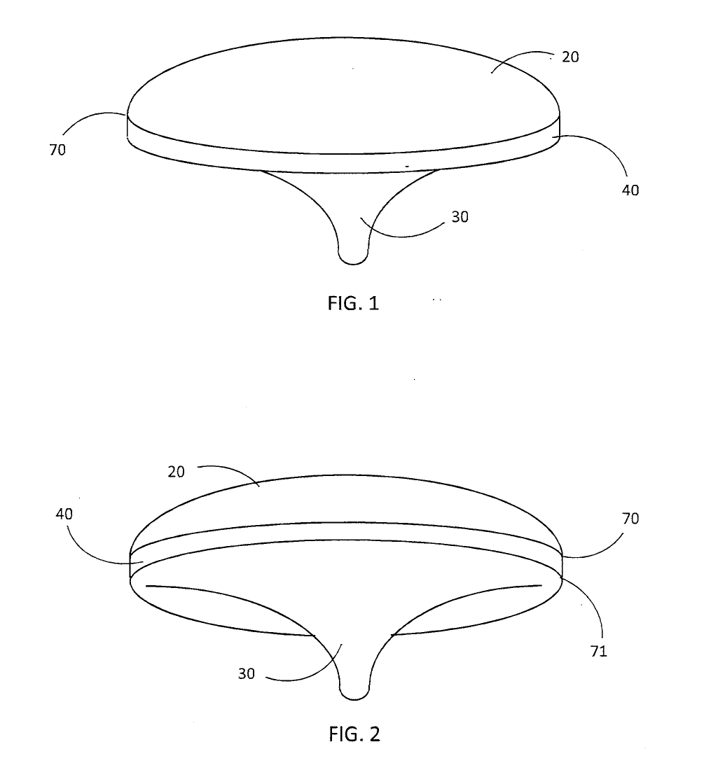

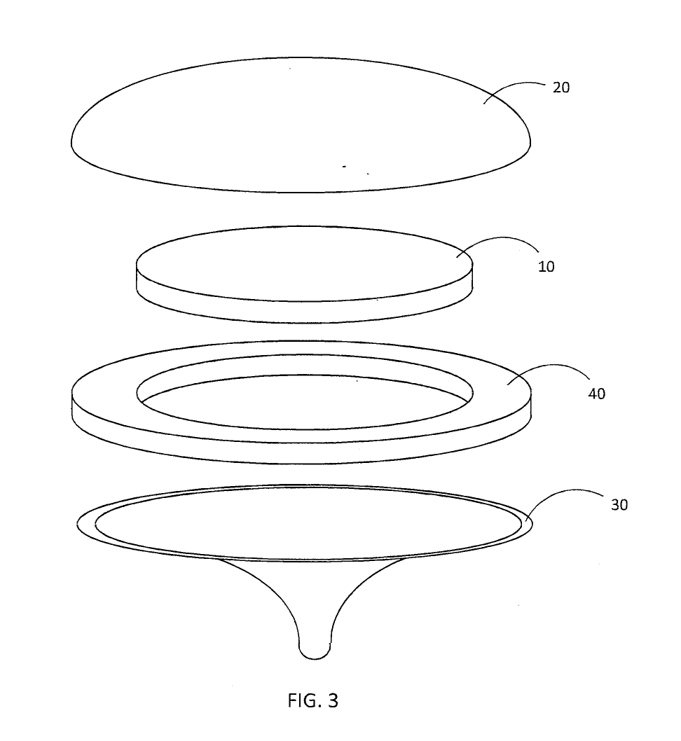

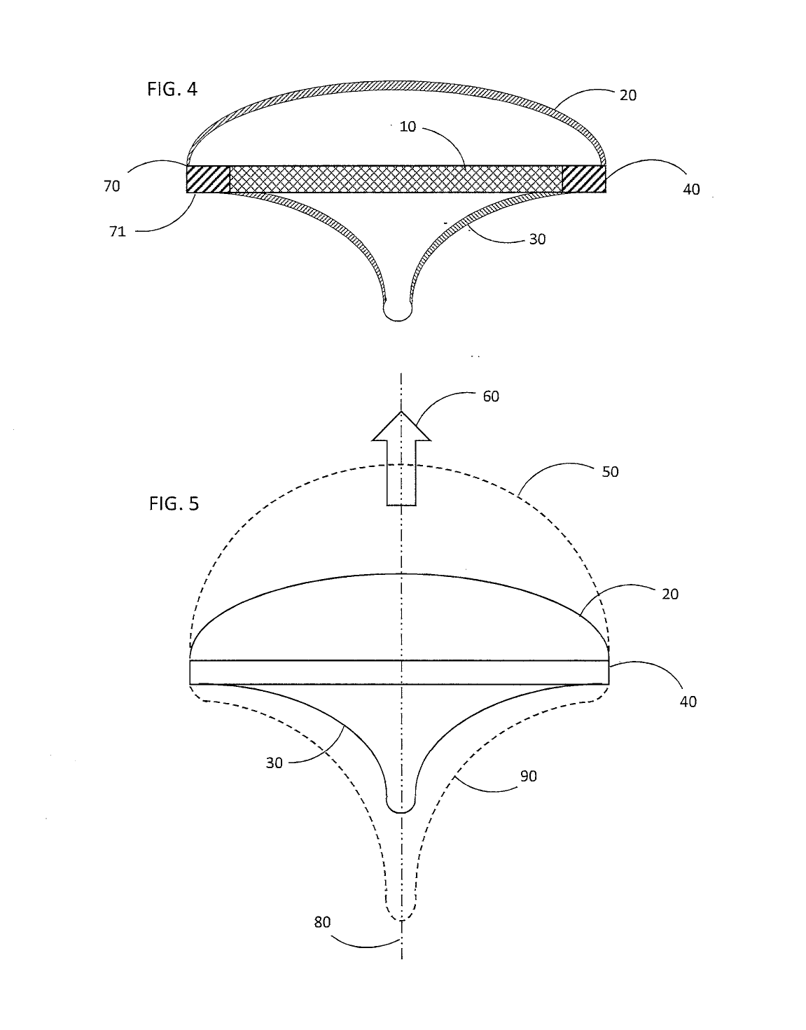

FIG. 1 through FIG. 5 illustrate a Relative Superluminal Propulsion Drive that consists of four (4) major components: the Vehicle 10, the Triggering Boson Absorption Antenna 20 (herein referred as the TBAA 20), the Triggering Boson Distribution Antenna 30 (herein referred to as the TBDA 30) and an electro-mechanical device 40 that can distribute triggering boson condensed from a zone 50 in front of the vehicle 10 located between the TBAA 20 and the TBDA 30 and distribute it to a zone 90 behind the vehicle 10. When arranged in the configuration shown in FIGS. 1, 2, 3, 4 and/or 5 the assembly of these four major components provide for the electro-mechanical means to provide propulsion and accelerate the vehicle 10 to a velocity greater than 299,792,458 meters/second when measured between two points in space that lay in the velocity path 60 (herein referred to as the direction of travel 60) of the invention.

The TBAA 20 is affixed to the electro-mechanical device 40 and the forward side vehicle 10 in such a manner at interface 70 to be permanent and to cause reactive forces to vehicle 10 in the desired direction of travel 60. The TBDA 30 is affixed to electro-mechanical device 40 at interface 71 relative to the aft side of vehicle 10 and the electro-mechanical device 40 along the desired direction of travel 60 and along the longitudinal axis 80. It is understood by those familiar with the art of propulsion drive location that the size, number and location of TBAA 20 and TBDA 30 can vary to optimize drive performance and that the illustrations shown do not limit the size, configuration, number and location of the TBAA 20 and TBDA 30 in relation to electro-mechanical device 40 and vehicle 10 to stay within the scope of this disclosure.

TBAA 20 is caused to absorb triggering boson from zone 50 forward of the desired direction of travel 60. The absorption of the triggering boson from zone 50 in front of vehicle 10 lowers the density and/or pressure of the void energy and triggering bosons in zone 50. The triggering bosons are then re-distributed via the electro-mechanical device 40 to the TBDA 30 for expulsion and emergence into zone 90 behind vehicle 10. This redistribution of the triggering bosons causes an increase in pressure and/or density of void energy and triggering bosons in zone 90 behind vehicle 10 relative to the pressure and/or density of void energy and triggering bosons in zone 50 in front of vehicle 10. This differential in pressure and/or density of void energy and triggering bosons applies force to vehicle 10 which causes vehicle 10 to be propelled into the area of lower void energy and triggering bosons created in zone 50 in front of vehicle 10.

As additional triggering boson are distributed from zone 50 the area in front of the vehicle 10 to zone 90 the area behind the vehicle 10 the localized ambient density and/or pressure gradient of the void energy and triggering bosons continues to increase behind vehicle 10 and vehicle 10 continues to accelerate into zone 50, its forward direction of travel 60. The vehicle 10 will continue to accelerate as long as the pressure gradient and/or pressure density of the void energy and triggering bosons attempts to equalize themselves between zone 50 and zone 90.

Steady-state velocity of vehicle 10 is achieved by the non-varying steady-state distribution of triggering boson from the forward side of the TBAA 20 to the aft side of the TBDA 30 via the electro-mechanical device 40. Accordingly, the faster the triggering boson is re-distributed from zone 50 in front of the TBAA 20 to zone 90 aft of the TBDA 30 via the electro-mechanical device 40 the faster the vehicle 10 will accelerate in the forward direction of travel 60.

The velocity of the vehicle is proportional to the rate of distribution of triggering boson from in front of the TBAA 20 to the aft of the TBDA 30. For example, if the triggering boson is re-distributed at a rate that consistently lowers the pressure ratio of the void energy from in front of the vehicle 10 to behind the vehicle 10 to a ratio of 1:4 then the present disclosure has a maximum theoretical velocity between two points in space of four (4) times the speed of light; in this case 1,199,169,832 meters per second.

It is believed that the present disclosure as described and many of its attendant advantages will be understood by the foregoing description. It is also believed that it will be apparent that various changes may be made in the form, appearance, design, construction and arrangement of the components thereof without departing from the scope and spirit of the invention. The form herein before described being merely exemplary and explanatory embodiment thereof. It is the intention of the following claims to encompass and include such changes.

What is claimed is:

1. An relative superluminal propulsion drive comprised of:
an electro-magnetic energy field generator/antenna designed to absorb (or collect) triggering boson;
an electro-magnetic energy field generator/antenna designed to release (or distribute) triggering boson;
and an electro-mechanical device design to redistribute triggering boson.

2. The relative superluminal propulsion drive of claim 1, wherein the electro-mechanical device design to redistribute triggering boson is attached to a body of mass.

3. The relative superluminal propulsion drive of claim 2, wherein the electro-magnetic energy field generator/antenna designed to absorb (or collect) triggering boson is affixed along the longitudinal axis in the forward direction of travel of the body of mass.

4. The relative superluminal propulsion drive of claim 2, wherein the electro-magnetic energy field generator/antenna designed to release (or distribute) triggering boson is affixed along the longitudinal axis in the aft direction of travel to the body of mass.

5. The relative superluminal propulsion drive of claim 2, wherein the electro-mechanical device design to redistribute triggering boson is affixed between the electro-magnetic energy field generator/antenna designed to absorb (or collect) triggering boson and the electro-magnetic energy field generator/antenna designed to release (or distribute) triggering boson.

6. The relative superluminal propulsion drive of claim 5, wherein the electro-mechanical device designed to redistribute triggering boson regulates the amount of triggering boson being distributed between the bow and stern of the body of mass.

7. The relative superluminal propulsion drive of claim 5, wherein the electro-mechanical device designed to redistribute triggering boson regulates the propulsive thrust.

8. The relative superluminal propulsion drive of claim 7, wherein the energy of the propulsive thrust is derived from the pressure differential in void energy surrounding the body of mass.

9. The relative superluminal propulsion drive of claim 7, wherein the energy of the propulsive thrust is derived from the density differential in void energy surrounding the body of mass.

10. The relative superluminal propulsion drive of claim 7, wherein the energy of the propulsive thrust is derived from the pressure differential in triggering boson surrounding the body of mass.

11. The relative superluminal propulsion drive of claim 7, wherein the energy of propulsive thrust is derived from the density differential in triggering boson surrounding the body of mass.
